(19) United States
(12) Patent Application Publication
(10) Pub. No.: US 2017/0003436 A1
(43) Pub. Date: Jan. 5, 2017

(54) SURFACE LIGHT SOURCE DEVICE AND DISPLAY DEVICE

(71) Applicant: DAI NIPPON PRINTING CO., LTD., Tokyo (JP)

(72) Inventors: Tatsuaki INOUE, Tokyo (JP); Masahiro GOTOU, Tokyo (JP); Hiroki MATSUSHITA, Tokyo (JP)

(73) Assignee: Dai Nippon Printing Co., Ltd., Tokyo (JP)

(21) Appl. No.: 15/125,717

(22) PCT Filed: Mar. 27, 2015
(86) PCT No.: PCT/JP2015/059571

§ 371 Date: Sep. 13, 2016

(30) Foreign Application Priority Data
Mar. 28, 2014 (JP) 2014-070294

(51) Int. Cl. F21V 8/00

(52) U.S. Cl. CPC G02B 6/0053; G02B 6/0051; G02B 6/0061; G02B 5/0226

(57) ABSTRACT

A surface light source device (20) includes a light guide plate (30), an optical sheet (60) and a light source (24). The optical sheet has unit prisms projecting toward the light guide plate and arranged in a first direction. The unit prism is composed of a first prism surface (71) facing the first direction, and a second prism surface (72) facing the other side of the first direction. The second prism surface (72) includes element surfaces (73) of different inclining angles. An inclining angle (θₜ) of each element surface, a length (Wₜ) of each element surface along the first direction and a length (W_{b2}) of the second prism surface (72) along the first direction satisfy predetermined conditions.

### TECHNICAL FIELD

The present invention relates to an edge-light type surface light source device, in particular, a surface light source device in which non-uniformity of luminance angular distributions in two planes perpendicular to each other is reduced while maintaining a high luminance in a front direction.

### BACKGROUND ART

As a backlight incorporated in, e.g., a liquid crystal display device for illuminating a liquid display panel from the back, a surface light source having a light emitting surface which planarly emits light has been widely used (for example, JP2004-46076A: Patent Document 1). A surface light source device for use in a liquid crystal display device is roughly classified into a directly below type in which a light source is located directly below an optimal member, and an edge light type (also referred to as side light type) in which a light source is located laterally to an optical member. As compared with the directly-below type surface light source device, the edge-light type surface light source device is excellent in that it can be reduced in width.

The edge-light type surface light source device disclosed in Patent Document 1 includes a light guide member, a light deflection element disposed to face a light exit surface of a light guide plate, and a light source disposed to face one side surface of the light guide member. In the surface light source device, most of light exiting from the light exit surface of the light guide member travels in a direction largely inclined in a light guide direction in the light guide member with respect to a normal direction of the light exit surface, e.g., in a direction inclined at 60° to 80° in the light guide direction in the light guide member with respect to the normal direction of the light exit surface. The light deflection element includes linear prisms arranged in a direction parallel with the light guide direction in the light guide member and projecting toward the light guide member. Each linear prism has a first prism surface serving as a light entrance surface to which largely inclined light from the light guide member enters, and a second prism surface that reflects the largely inclined light to direct the light toward the front direction. In the surface light source device of Patent Document 1, the second prism surface is formed as a bent surface to reinforce a deflection function of the light deflection element, to thereby efficiently use light of the light source.

Recently, small portable terminals called cellular phone and tablet have become prevalent rapidly. A liquid crystal display device including an edge-light type surface light source device, which is capable of achieving reduction in width, is applied to most cellular phones and small portable terminals. In a display device of a cellular phone or a small portable terminal, an orientation in which an image is displayed is changed depending on a direction in which the cellular phone or the small portable terminal is held. A user can suitably observe an image in a horizontally long display surface or in a vertically long display surface, depending on an image to be displayed. In a surface light source device used for this application, non-uniformity of luminance angular distributions in two planes perpendicular to each other is preferably reduced in order not that brightness of image and a viewing angle change depending on an orientation in which an image is observed. On the other hand, the cellular phone and the small portable terminal are eagerly required to have a high luminance in a front direction, while saving electric power.

### DISCLOSURE OF THE INVENTION

The present invention has been made in view of the above circumstances. The object of the present invention is to provide a surface light source device in which non-uniformity of luminance angular distributions in two planes perpendicular to each other is reduced while maintaining a high luminance in a front direction, and a display device including this surface light source device.

A surface light source device according to the present invention comprises:

a light guide plate including a light exit surface, and a pair of side surfaces opposed in a first direction;

an optical sheet disposed to face the light exit surface of the light guide plate; and

a light source disposed to face a side surface of the light guide plate positioned on one side in the first direction;

wherein:

the optical sheet includes a sheet-like body part, and unit prisms arranged on a side of the light guide plate of the body part in the first direction, each unit prism extending linearly in a direction intersecting the first direction;

each unit prim includes a first prism surface facing one side of the first direction, and a second prism surface facing the other side of the first direction;

the second prism surface includes element surfaces the number of which is n (n is a natural number of 2 or more), the element surfaces being arranged such that, in a main cross-section of the optical sheet in parallel both with the first direction and a normal direction of the body part, an inclining angle with respect to the first direction gradually increases from a side of a distal end portion of a unit prism farthest from the body part toward a side of a proximal end portion of a unit prism closest to the body part;

the following two conditions (a) and (b) are satisfied:

$$\begin{matrix}3.25 ≦ {\sum }_{t = 1}^{n} ( \vert {θ}_{t} - {θ}_{ave} \vert \times ( {W}_{t} / {W}_{b 2} ) ) ≦ 8.50 & ( a ) \\ {θ}_{ave} = {\sum }_{t = 1}^{n} ( {θ}_{t} \times ( {W}_{t} / {W}_{b 2} ) ) & ( b )\end{matrix}$$

where θₜ is an angle between an element surface, which is located at a t-th position (t is a natural number satisfying 1≦t≦n) from the side of the distal end portion of the unit prism toward the side of the proximal end portion thereof, and the first direction in the main cross-section of the optical sheet, the angle θₜ being less than 180°, Wₜ is a length of the t-th element surface along the first direction, and W_{b2} is a length of the second prism surface in the main cross-section of the optical sheet along the first direction;

in the main cross-section of the optical sheet, a ratio (W_{b}/H_{b}) of a width W_{b} of the unit prism along the first direction with respect to a height H_{b} of the unit prism along the normal direction of the body part satisfies the following condition (c):

1.15≦W_{b}/H_{b}≦1.4 (c); and

in an angular distribution of luminance on the light exit surface of the light guide plate toward respective directions in a plane in parallel both with the normal direction of the light guide plate and the first direction, θₐₗₘₐₓ₁ defined by an inclining angle wherein a direction in which a peak luminance is obtained is inclined from the normal direction of the light guide plate to the other side along the first direction, and θ_{alα1} defined by an inclining angle wherein a direction in which a luminance half of the peak luminance is obtained, the direction being located between the normal direction of the light guide plate and the direction in which the peak luminance is obtained, is inclined from the direction in which the peak luminance is obtained to one side along the first direction satisfy the following conditions (d) and (e):

60°≦θₐₗₘₐₓ₁≦80° (d)

5°≦θ_{alα1}≦25° (e).

In the surface light source device according to the present invention, in an angular distribution of luminance on the light exit surface of the light guide plate toward respective directions in a plane in parallel with the normal direction of the light guide plate and perpendicular to the first direction, θₐₗₘₐₓ₂ defined by an inclining angle wherein a direction in which a peak luminance is obtained is inclined from the normal direction of the light guide plate, and θ_{alα2} defined by an average value of inclining angles wherein directions in which a luminance half of the peak luminance is obtained, the directions being located on both sides of the direction in which the peak luminance is obtained, are inclined from the direction in which the peak luminance is obtained may satisfy the following conditions (f) and (g):

θ_{aImax}≦3° (f)

12°≦θ_{aIα2}≦27° (g).

In the surface light source device according to the present invention, a light diffusion layer may be formed on a surface opposed to the side of the light guide plate of the optical sheet.

In the surface light source device according to the present invention, the second prism surface may include element surfaces the number of which is n (n is a natural number of 3 or more), the element surfaces being arranged such that, in the main cross-section of the optical sheet in parallel both with the first direction and the normal direction of the body part, an inclining angle with respect to the first direction gradually increases from the side of the distal end portion of a unit prism farthest from the body part toward the side of the proximal end portion of a unit prism closest to the body part.

A display device according to the present invention comprises:

the surface light source device according to any one of the above; and

a display panel disposed to face the surface light source device.

The present invention can provide a surface light source device in which non-uniformity of luminance angular distributions in two planes perpendicular to each other is reduced while maintaining a high luminance in a front direction.

### BRIEF DESCRIPTION OF THE DRAWINGS

FIG. 1 is a diagram illustrating an embodiment of the present invention, and is a cross-sectional view showing a schematic construction of a display device and a surface light source device.

FIG. 2 is a diagram illustrating the action of the surface light source device of FIG. 1.

FIG. 3 is a perspective view, showing, from the side of its light exit surface, a light guide plate incorporated in the surface light source device of FIG. 1.

FIG. 4 is a perspective view showing, from the side of its back surface, the light guide plate incorporated in the surface light source device of FIG. 1.

FIG. 5 is a diagram illustrating the action of the light guide plate, showing the light guide plate in a cross-section along the line V-V of FIG. 3.

FIG. 6 is a perspective view showing an optical sheet incorporated in the surface light source device of FIG. 1.

FIG. 7 is a partial cross-sectional view showing the optical sheet of FIG. 6 in the main cross-section (cross-section along the line VII-VII of FIG. 6).

FIG. 8 is a diagram illustrating the action of the optical sheet, and is a partial cross-sectional view showing the surface light source device in the cross-section similar to that of FIG. 7.

FIG. 9 is a graph showing the angular distribution of luminance on the light exit surface of the light guide plate, in a plane in parallel both with a front direction and a first direction.

FIG. 10 is a graph showing the angular distribution of luminance on the light exist surface of the light guide plate, in a plane in parallel both with a front direction and a second direction.

FIG. 11 is a graph showing the angular distribution of luminance on the light exit surface of the optical sheet, in a plane in parallel both with the front direction and the first direction.

FIG. 12 is a graph showing the angular distribution of luminance on the light exit surface of the optical sheet, in a plane in parallel both with the front direction and a second direction.

FIG. 13 is a cross-sectional view showing a modification example of the optical sheet in the main cross-section.

### DESCRIPTION OF THE PREFERRED EMBODIMENTS

Preferred embodiments of the present invention will now be described with reference to the drawings. In the drawings attached hereto, scales, horizontal to vertical dimensional ratios, etc. are exaggeratingly modified from those of the real things for the sake of illustration and easier understanding.

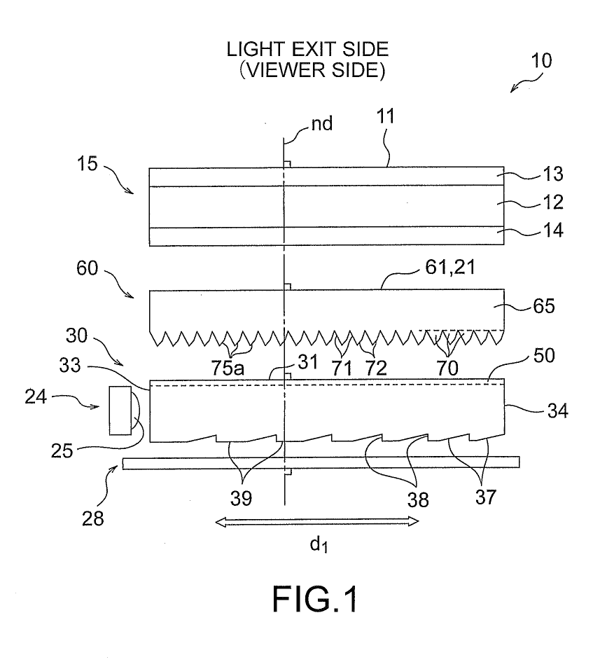

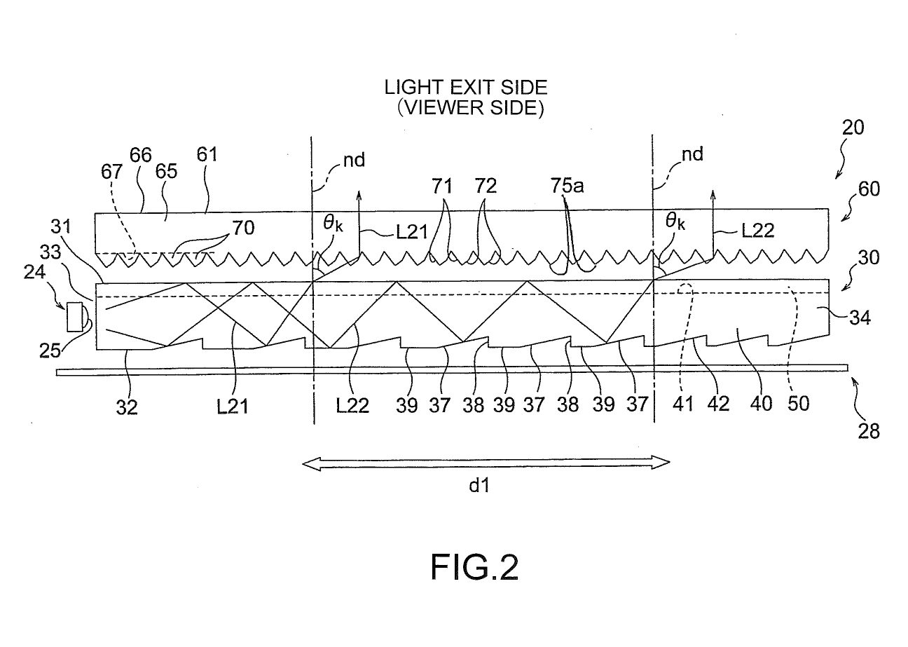

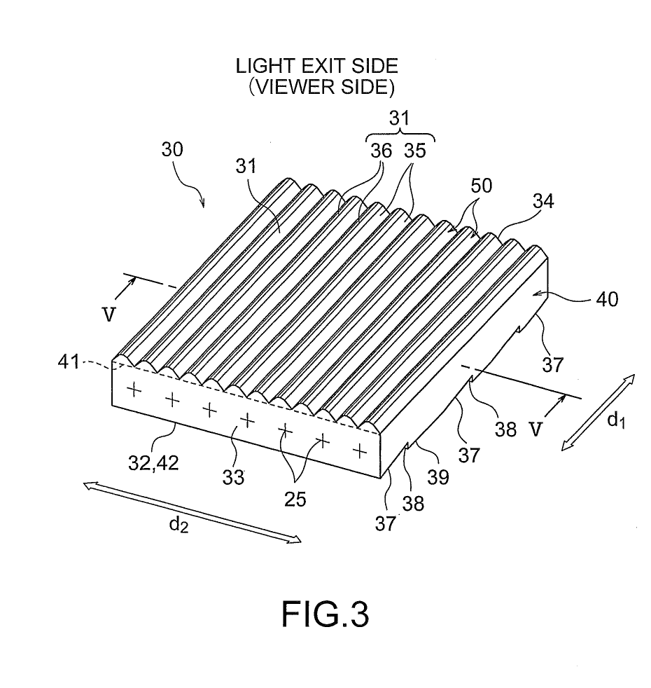

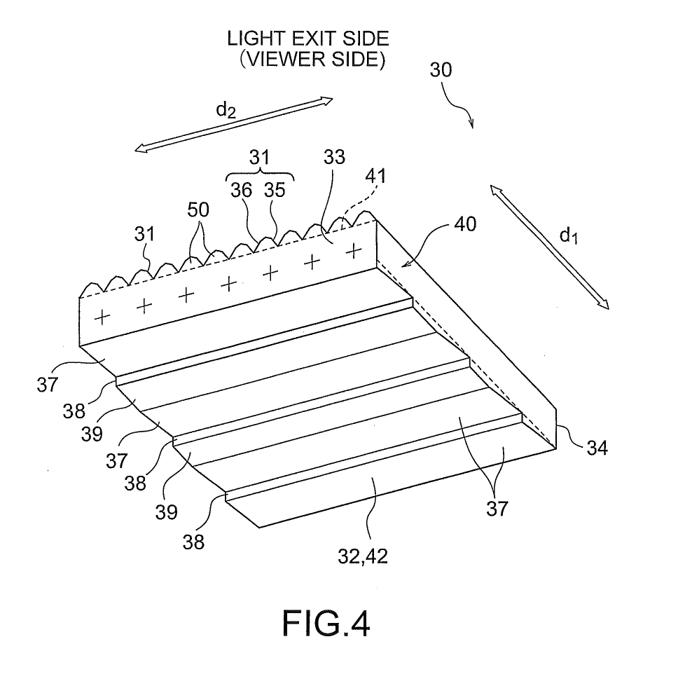

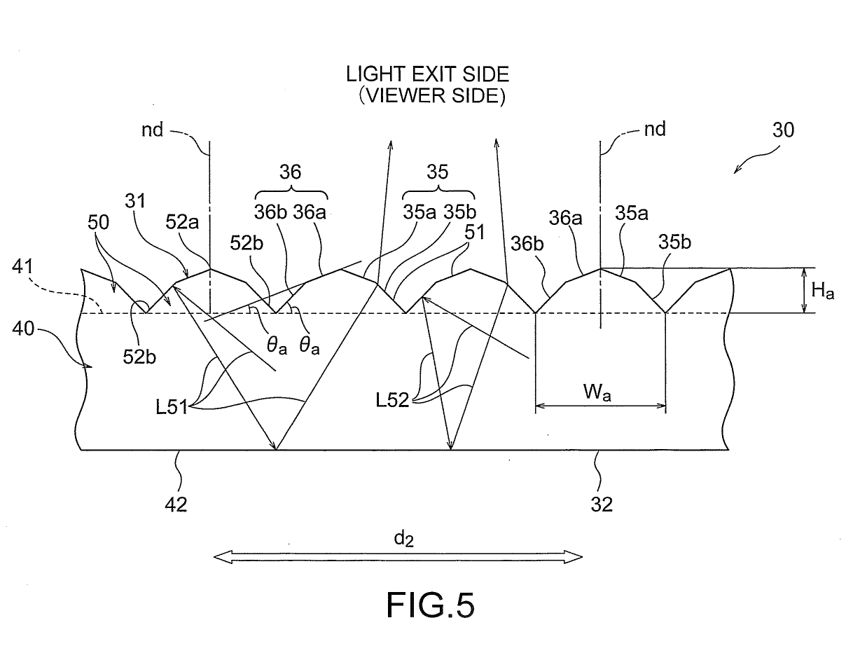

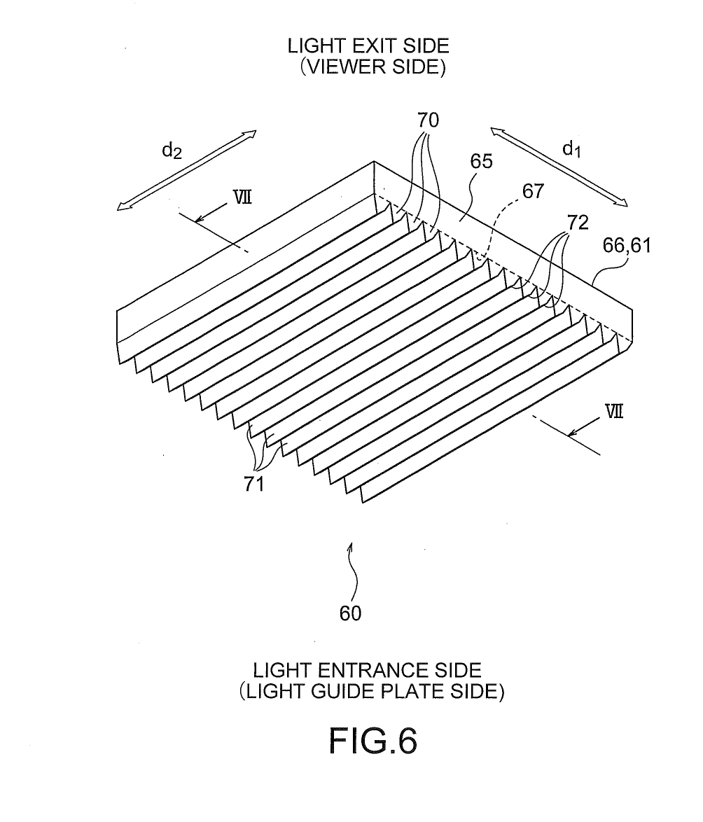

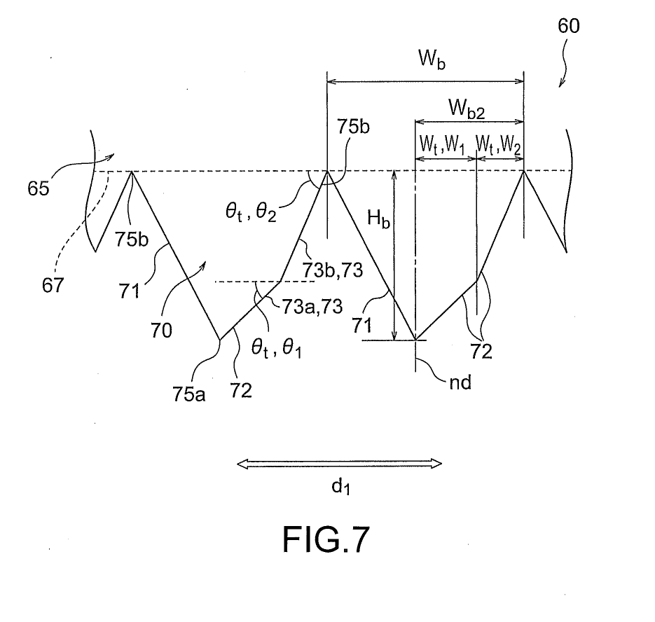

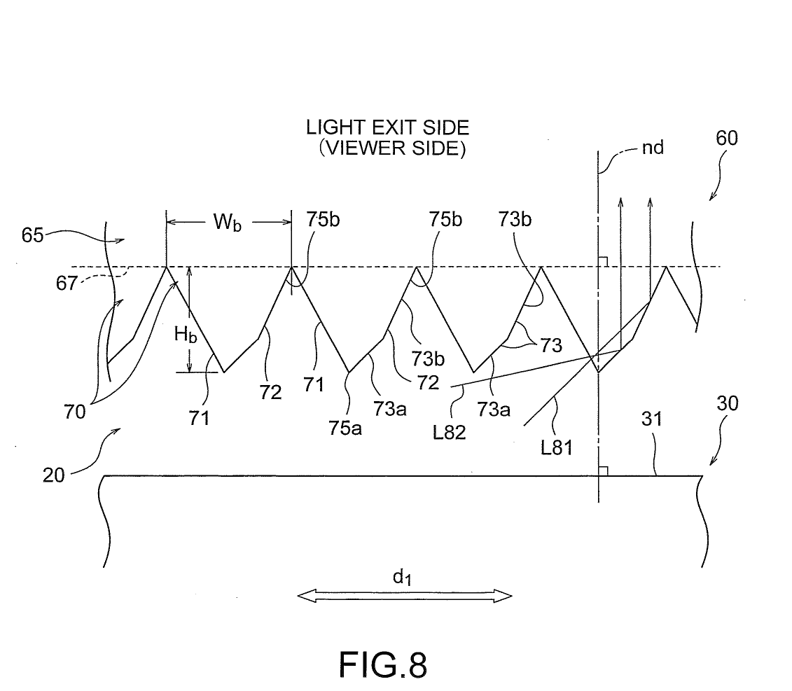

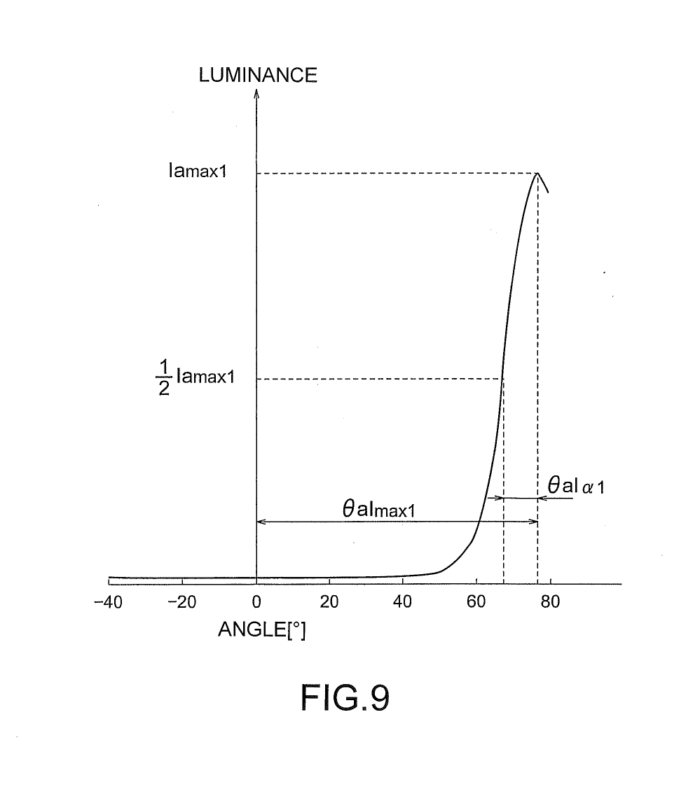

FIGS. 1 to 8 are diagrams illustrating an embodiment of the present invention. FIG. 1 is a cross-sectional view showing a schematic construction of a liquid crystal display device and a surface light source device. FIG. 2 is a cross-sectional view illustrating the action of the surface light source device. FIGS. 3 and 4 are perspective views showing a light guide plate included in the surface light source device. FIG. 5 is a cross-sectional view showing the light guide plate in the main cross-section of the light guide plate. FIG. 6 is a perspective view showing the optical sheet included in the surface light source device. FIGS. 7 and 8 are cross-sectional view showing the optical sheet in the main cross-section. FIGS. 9 to 12 are views showing examples of angular distribution of luminance on the light exit surface of the light guide plate of the surface light source device or on the light exit surface of the optical sheet.

As shown in FIG. 1, the display device 10 includes a liquid crystal display panel 15 and a surface light source device 20, disposed behind the liquid crystal display panel 15, for planarly illuminating the liquid crystal display panel 15 from the back. The display device 10 has a display surface 11 for displaying an image on it. The liquid crystal display panel 15 is configured to function as a shutter which controls transmission and blocking of light from the surface light source device 20 for each pixel, and form an image on the display surface 11.

The illustrated liquid crystal display panel 15 includes an upper polarizing plate 13 disposed on the light exit side, a lower polarizing plate 14 disposed on the light entrance side, and a liquid crystal cell 12 disposed between the upper polarizing plate 13 and the lower polarizing plate 14. The polarizing plates 14, 13 function to resolve incident light into two orthogonal polarization components (P wave and S wave), and transmit a linear polarization component (e.g. P wave) vibrating in one direction (direction parallel to the transmission axis) and absorb a linear polarization component (e.g. S wave) vibrating in the other direction perpendicular to the one direction (parallel to the absorption axis).

An electric field can be applied to each pixel area of the liquid crystal layer 12. The orientation direction of liquid crystal molecules in the liquid crystal layer 12 changes depending on application/non-application of an electric field. For example, a polarization component vibrating in a particular direction, which has passed through the lower polarizing plate 14 disposed on the light entrance side, turns its polarization direction by 90 degrees when it passes through the liquid crystal layer 12 to which an electric field is being applied, whereas the polarization component maintains its polarization direction when it passes through the liquid crystal layer 12 to which no electric field is being applied. Thus, transmission through or absorption and blocking by the upper polarizing plate 13, disposed on the light exit side of the lower polarizing plate 14, of the polarization component vibrating in the particular direction, which has passed through the lower polarizing plate 14, can be controlled by application/non-application of an electric field to the liquid crystal layer 12.

In this manner, the liquid crystal display panel (liquid crystal display section) 15 can control transmission or blocking of light from the surface light source device 20 for each pixel. The details of the liquid crystal display panel 15 are known from a number of documents (e.g. “Dictionary of Flat Panel Display”, edited by T. Uchida and H. Uchiike, 2001, Kogyo Chosakai Publishing Co., Ltd.), and hence a further detailed description thereof is omitted.

The surface light source device 20 will now be described. The surface light source device 20 has a light emitting surface 21 which planarly emits light, and in this embodiment is used as a device for illuminating the liquid crystal display panel 15 from the back.

As shown in FIG. 1, the surface light source device 20 is configured as an edge-light type surface light source device, and includes a light guide plate 30, a light source 24 disposed lateral to one side (left side in FIG. 1) of the light guide plate 30, an optical sheet (prism sheet) 60 and a reflective sheet 28, both disposed to face the light guide plate 30. In the illustrated embodiment, the optical sheet 60 is disposed in a position directly facing the liquid crystal display panel 15. The light exit surface of the optical sheet 60 defines a light emitting surface 21.

In the illustrated embodiment, as with the display surface 11 of the liquid crystal display device 10 and the light emitting surface 21 of the surface light source device 20, the light exit surface 31 of the light guide plate 30 is formed in a square shape in a plan view (as viewed from above in FIG. 1). Thus, the light guide plate 30 is configured as a cuboidal member having a pair of main surfaces (light exit surface 31 and back surface 32) and four side surfaces defined between the pair of main surfaces, and in which the thickness-direction sides are shorter than the other sides. Likewise, the optical sheet 60 and the reflective sheet 28 are each configured as a cuboidal member in which the thickness-direction sides are shorter than the other sides.

The light guide plate 30 has the light exit surface 31 which is the main surface on the side of the liquid crystal display panel 15, the back surface 32 which is the other main surface opposite to the light exit surface 31, and the side surfaces extending between the light exit surface 31 and the back surface 32. One of two side surfaces that oppose each other in a first direction d₁ is a light entrance surface 33. As shown in FIG. 1, the light source 24 is disposed opposite the light entrance surface 33. Light that has entered the light guide plate 30 through the light entrance surface 33 is guided in the light guide plate 30 approximately along the first direction (light guide direction) d₁ toward an opposite surface 34 that opposes the light entrance surface 33. As shown in FIGS. 1 and 2, the optical sheet 60 is disposed opposite the light exit surface 31 of the light guide plate 30, and the reflective sheet 28 is disposed opposite the back surface 32 of the light guide plate 30.

Various types of light emitters, including a linear cold-cathode tube, a fluorescent tube, point-like LEDs (light emitting diodes), an incandescent bulb, etc., can be used as the light source 24. In this embodiment the light source 24 is comprised of a large number of point-like light emitters 25, in particular light emitting diodes (LEDs), arranged side by side along the longitudinal direction (direction perpendicular to the plane of the paper, i.e. the normal direction to the plane, in FIG. 1) of the light entrance surface 33. The arrangement positions of the point-like light emitters 25 constituting the light source 24 are shown in the light guide plate 30 shown in FIGS. 3 and 4.

The reflective sheet 28 is a member to reflect light that has leaked from the back surface 32 of the light guide plate 30 so that the light will re-enter the light guide plate 30. The reflective sheet 28 may be comprised of a white scattering reflection sheet, a sheet composed of a material having high reflectance, such as a metal, a sheet having a surface film layer of a high-reflectance material (e.g. a metal film), or the like. The reflection of light from the reflective sheet 28 may be regular reflection (mirror reflection) or diffuse reflection. In the case where the reflection of light from the reflective sheet 28 is diffuse reflection, the diffuse reflection may be isotropic diffuse reflection or anisotropic diffuse reflection.

The term “light exit side” herein refers to downstream side (viewer side, e.g. upper side in FIG. 1) in the traveling direction of light that travels between the components of the display device 10, namely the light source 24, the light guide plate 30, the optical sheet 60 and the liquid crystal display panel 15, without turning back, and exits the display device 10 and travels toward a viewer. The term “light entrance side” herein refers to upstream side in the traveling direction of light that travels between the components of the display device 10, namely the light source 24, the light guide plate 30, the optical sheet 60 and the liquid crystal display panel 15, without turning back, and exits the display device 10 and travels toward a viewer.

The terms “sheet”, “film”, “plate”, etc. are not used herein to strictly distinguish them from one another. Thus, the term “sheet” includes a member which can also be called a film or plate.

The term “sheet plane (plate plane, film plane)” herein refers to a plane which coincides with the planar direction of an objective sheet-like member when taking a wide and global view of the sheet-like member. In this embodiment the plate plane of the light guide plate 30, the sheet plane (plate plane) of the below-described base portion 40 of the light guide plate 30, the sheet plane of the optical sheet 60, the sheet plane of the reflective sheet 28, the panel plane of the liquid crystal display panel, the display surface 11 of the display device 10, and the light emitting surface 21 of the surface light source device 20 are parallel to each other. The term “front direction” herein refers to the normal direction to the light emitting surface 21 of the surface light source device 20, and in this embodiment coincides with the normal direction to the plate plane of the light guide plate 30, the normal direction to the sheet plane of the optical sheet 60, the normal direction to the display surface 11 of the display device 10, etc. (see e.g. FIG. 2).

The light guide plate 30 will now be described in greater detail mainly with reference to FIGS. 2 through 5. As well shown in FIGS. 2 through 5, the light guide plate 30 comprises a base portion 40 formed in a plate-like shape, and a number of unit optical elements 50 formed on a one-side surface (viewer-facing surface, light exit-side surface) 41 of the base portion 40. The base portion 40 is configured as a flat plate-like member having a pair of parallel main surfaces. The other-side surface 42 of the base portion 40, which faces the reflective sheet 28, constitutes the back surface 32 of the light guide plate 30.

The terms “unit prism”, “unit shaped element”, “unit optical element” and “unit lens” herein refer to an element which functions to exert an optical action, such as refraction or reflection, on light and to thereby change the traveling direction of the light, and are not used herein to strictly distinguish them from one another.

As well shown in FIG. 4, the other-side surface 42 of the base portion 40, constituting the back surface 32 of the light guide plate 30, is configured as an uneven surface. In a specific construction, the back surface 32 has inclined surfaces 37, stepped surfaces 38 extending in the normal direction nd of the light guide plate 30, and connecting surfaces 39 extending in the plate-plane direction of the light guide plate 30, which define the irregularities of the other-side surface 42 of the base portion 40. Light is guided in the light guide plate 30 through total reflection at the pair of main surfaces 31, 32 of the light guide plate 30. On the other hand, each inclined surface 37 is inclined with respect to the plate plane of the light guide plate 30 such that the distance to the light exit surface 31 decreases with the increasing distance from the light entrance surface 33. Accordingly, the incident angle of light entering the main surface 31, 32 becomes smaller after the light reflects at an inclined surface 37. When the incident angle of light to the main surface 31, 32 becomes less than the critical angle for total reflection by reflection of the light at an inclined surface(s) 37, the light will exit the light guide plate 30. Thus, each inclined surface 37 functions as an element to extract light from the light guide plate 30.

The distribution of the amount of light exiting the light guide plate 30 along the first direction d₁ which is the light guide direction can be controlled by adjusting the distribution of the inclined surfaces 37 along the first direction d₁ in the back surface 32. In the embodiment illustrated in FIGS. 2 through 5, the proportion of the area of an inclined surface 37 in the back surface 32 increases as the distance of the inclined surface 37 from the light entrance surface 33 in the light guide direction increases. According to the thus-constructed light guide plate 30, exit of light from the light guide plate 30 is promoted in a region remote from the light entrance surface 33 along the light guide direction. This can effectively prevent decrease in the amount of exiting light with the increasing distance from the light entrance surface 33.

Unit optical elements 50 provided on the one-side surface 41 of the base portion 40 will now be described. As well shown in FIG. 3, the unit optical elements 50 are arranged side by side on the one-side surface 41 of the base portion 40 in an arrangement direction (lateral direction in FIG. 3) intersecting the first direction d₁ and parallel to the one-side surface 41 of the base portion 40. Each unit optical element 50 extends linearly on the one-side surface 41 of the base portion 40 in a direction intersecting the arrangement direction.

Particularly in this embodiment, as shown in FIG. 3, the unit optical elements 50 are arranged on the one-side surface 41 of the base portion 40 side by side with no space therebetween in a second direction (arrangement direction) d₂ perpendicular to the first direction d₁. Thus, the light exit surface 31 of the light guide plate 30 consists of the inclined surfaces 35, 36 of the unit optical elements 50. Each unit optical element 50 extends in a straight line along the first direction d₁ perpendicular to the arrangement direction. Each unit optical element 50 has a columnar shape, and has the same cross-sectional shape along the longitudinal direction. Further, in this embodiment all the unit optical elements 50 have the same construction. Accordingly, the light guide plate 30 of this embodiment has a constant cross-sectional shape at various positions along the first direction d₁.

A description will now be given of the cross-sectional shape of the unit optical elements 50 in the cross-section shown in FIG. 5, i.e. the cross-section parallel to both the arrangement direction (second direction) of the unit optical elements 50 and the normal direction nd to the one-side surface 41 of the base portion 40 (plate plane of the light guide plate 30) (hereinafter also referred to simply as the “main cross-section”). As shown in FIG. 5, in the illustrated embodiment, each unit optical element 50 has a tapered cross-sectional shape, tapered toward the light exit side, in the main cross-section of the light guide plate 30. Thus, in the main cross-section of the light guide plate 30, the width of each unit optical element 50, along a direction parallel to the plate plane of the light guide plate 30, decreases with distance from the base portion 40 in the normal direction nd of the light guide plate 30.

Further, in this embodiment, in the contour 51 (corresponding to the light exit surface 31) of each unit optical element 50 in the main-cross section, a light exit surface angle θa, which is the angle of the contour with respect to the one-side surface 41 of the base portion 40, changes such that it increases with distance from the top 52a of the contour 51 of the unit optical element 50, i.e. the farthest point from the base portion 40, and takes a maximum value at either base end portion 52b located closest to the base portion 40. The light exit surface angle θa can be set, for example, in the manner disclosed in Japanese Patent Laid-Open Publication No. 2013-51149.

As described above, the light exit surface angle θa refers to the angle of the light exit-side surface (contour) 51 of a unit optical element 50 with respect to the one-side surface 41 of the base portion 40 in the main cross-section of the light guide plate 30. When the contour (light exit-side surface) 51 of each unit optical element 50 in the main cross-section has the shape of a polygonal line as in the embodiment illustrate in FIG. 5, the light exit surface angle θa refers to the angle formed between a straight line segment of the polygonal line and the one-side surface 41 of the base portion 40 (more precisely the smaller one (minor angle) of the two angles formed). On the other hand, when the contour (light exit-side surface) 51 of each unit optical element 50 in the main cross-section has the shape of a curved line, the light exit surface angle θa refers to the angle formed between a tangent to the curved contour 51 of a unit optical element 50 and the one-side surface 41 of the base portion 40 (more precisely the smaller one (minor angle) of the two angles formed).

The exemplary unit optical elements 50 shown in FIG. 5 each have, in the main cross-section of the light guide plate 30, a pentagonal shape whose one side lies on the one-side surface 41 of the base portion 40 and whose two sides lie between the top 52a and each base end portion 52b of the contour 51, or a shape in which one or more of the corners of the polygonal shape are chamfered. In the illustrated embodiment, in order to effectively increase the front-direction luminance and to impart symmetry to the angular distribution of luminance in a plane along the second direction d₂, the cross-sectional shape of each unit optical element 50 in the main cross-section is made symmetrical with respect to the front direction nd. In particular, as well shown in FIG. 5, the light exit-side surface 51 of each unit optical element 50 is composed of a pair of bent surfaces 35, 36 which are symmetrical with respect to the front direction nd. The pair of bent surfaces 35, 36 are connected to each other, and the connection defines the top 52a. The pair of bent surfaces 35, 36 consist of a pair of first surfaces 35a, 36a that define the top 52a, and a pair of second surfaces 35b, 36b extending from the base portion 40 and connecting to the first surfaces 35a, 36a, respectively. The pair of first surfaces 35a, 36a are symmetrical with respect to the front direction nd, and the pair of second inclined surfaces 35b, 36b are also symmetrical with respect to the front direction nd.

In the main cross-section of the light guide plate 30, the ratio (Ha/Wa) of the height Ha of each unit optical element 50 from the base portion 40 in the front direction to the width Wa of the unit optical element 50 in the arrangement direction is preferably not less than 0.3 and not more than 0.45. Such unit optical elements 50, through refraction and reflection at the light exit-side surface 51, can exert excellent light condensing effect on a light component traveling along the arrangement direction (second direction) in which the unit optical elements 50 are arranged and, in addition, can effectively prevent side lobe.

The term “pentagonal shape” herein includes not only a pentagonal shape in the strict sense but also a generally pentagonal shape that may reflect limitations in production technique, a molding error, etc. Similarly, the terms used herein to specify shapes or geometric conditions, such as “parallel”, “perpendicular”, “symmetrical”, etc., should not be bound to their strict sense, and should be construed to include equivalents or resemblances from which the same optical function or effect can be expected.

The dimensions of the light guide plate 30 may be set as follows. The width Wa (see FIG. 5) of each unit optical element 50 may be not less than 10 μm and not more than 500 μm. The thickness of the base portion 40 may be in the range of 0.2 mm to 6 mm.

The thus-constructed light guide plate 30 can be produced e.g. by shaping the unit optical elements 50 on a substrate or by extrusion. While a variety of materials can be used for the base portion 40 of the light guide plate 30 and for the unit optical elements 50, it is preferred to use those materials which are widely used for optical sheets to be incorporated into display devices, have excellent mechanical properties, optical properties, stability and processability, and are commercially available at low costs. Examples of such materials include a transparent resin mainly comprising at least one of an acrylic resin, polystyrene, polycarbonate, polyethylene terephthalate, polyacrylonitrile, etc., and a reactive resin (e.g. ionizing radiation curable resin) such as an epoxy acrylate resin or a urethane acrylate resin. The light guide plate 30 may optionally contain a diffusing component which functions to diffuse light in the light guide plate 30. Particles of a transparent material such as silica (silicon dioxide), alumina (aluminum oxide), an acrylic resin, a polycarbonate resin or a silicone resin, having an average particle size of about 0.5 to 100 μm, may be used as the diffusing component.

When the light guide plate 30 is produced by curing an ionizing radiation curable resin on a substrate, it is possible to form, together with the unit optical elements 50, a sheet-like land portion between the substrate and the unit optical elements 50. In this case, the base portion 40 consists of the substrate and the land portion formed from the ionizing radiation curable resin. A plate-like resin extrudate containing light diffusing particles can be used as the substrate. When extrusion is employed to produce the light guide plate 30, the base portion 40 and the unit optical elements 50 on the one-side surface 41 of the base portion 40 can be formed integrally.

The optical sheet (prism sheet) 60 will now be described in greater detail mainly with reference to FIG. 2 and FIGS. 6 through 8. The optical sheet 60 is a member which functions to change the traveling direction of transmitted light.

As well shown in FIG. 6, the optical sheet 60 includes a body part 65 that is formed in a plate-like shape, and unit prisms (unit shaped elements, unit optical elements, unit lenses) 70 formed on a light entrance side surface 67 of the body part 65. The body part 65 is formed as a flat plate-like member having a pair of parallel main surfaces. A light exit surface 61 of the optical sheet 60 is formed as a light exit side surface 66 of the body part 65, which is located on the side not facing the light guide plate 30.

Next, the unit prisms 70 provided on the light entrance side surface of the body part 65 are described. As well shown in FIGS. 2 and 6, the unit prisms 70 are arranged side by side on the light entrance side surface of the body part 65. Each unit prism 70 has a columnar shape and extends in a direction intersecting their arrangement direction.

In this embodiment, each unit prism 70 extends in a straight line. In addition, each unit prism 70 has a columnar shape, and has the same cross-sectional shape along the longitudinal direction. The unit prisms 70 are arranged side by side with no space therebetween in a direction perpendicular to the longitudinal direction. Thus, a light entrance surface 62 of the optical sheet 60 is formed by surfaces (prism surfaces) 71, 72 of the unit prisms 70 that are arranged side by side without no space therebetween on the body part 65.

As describe above, the optical sheet 60 is disposed so as to be superimposed on the light guide plate 30, so that the unit prisms 70 of the optical sheet 60 face the light exit surface 31 of the light guide plate 30. As shown in FIGS. 1 and 2, the optical sheet 60 is positioned with respect to the light guide plate 30 such that the longitudinal direction of the unit prism 70 intersects a light guide direction of the light guide plate 30 (first direction connecting the light entrance surface 33 of the light guide plate 30 and the opposite surface 34 opposed to the light entrance surface) d₁. More strictly, the optical sheet 60 is positioned with respect to the light guide plate 30 such that the longitudinal direction of the unit prisms 70 is perpendicular to the light guide direction (i.e., first direction) d₁ of the light guide plate 30, and that the arrangement direction of the unit prisms 70 is in parallel with the light guide direction d₁ of the light guide plate 30. Thus, each unit prism 70 extends in a second direction d₂ in parallel with the arrangement direction of the unit optical elements 50.

As well shown in FIG. 2, each unit prism 70 has a first prism surface 71 and a second prism surface 72 that are arranged opposedly to each other along the arrangement direction of the unit prisms 70, i.e., the first direction d₁. The first prism surface 71 of each unit prism 70 is located on one side of the first direction (left side in sheet planes of FIGS. 1 and 2), and the second prism surface 72 is located on the other side of the first direction (right side in the sheet planes of FIGS. 1 and 2). In more detail, the first prism surface 71 of each unit prim 70 is located on the side of the light source 24 in the first direction d₁ and faces the one side in the first direction d₁. The second prism surface 72 of each unit prism 70 is located on the side distant from the light source 24 in the first direction d₁ and faces the other side in the first direction d₁. As described below, the first prism surface 71 basically functions as an incident surface for light that has been emitted from the light source 24, disposed on one side in the first direction d₁, and traveled into the light guide plate 30, then exited the light guide plate 30 and enters the optical sheet 60. On the other hand, the second prism surface 72 has a function for reflecting light that has entered the optical sheet 60, thereby correcting the path of the light.

As well shown in FIGS. 7 and 8, the first prism surface 71 and the second prism surface 72 respectively extend from the body part 65 and are connected to each other. Proximal end portions 75b of the unit prism 70 are defined at positions where the first prism surface 71 and the second prism surface 72 respectively connect to the body part 65. A distal end portion (top) 75a of the unit prism 70, located farthest from the body part 65, is defined at a position where the first prism surface 71 and the second prism surface 72 connect to each other.

As described above, and as shown in FIGS. 7 and 8, a cross-sectional shape of each unit prism 70 in a cross-section in parallel both with the normal direction nd of the body part 65 normal to the sheet plane (the light entrance side surface 67 of the body part 65, the sheet plane of the optical sheet 60) and with the first direction d₁ that is the arrangement direction of the unit prisms 70 (referred to simply as main cross-section of the optical sheet) is constant along the longitudinal direction of the unit prism 70 (direction extending in a straight line).

Herebelow, the cross-sectional shape of the unit prism 70 in the main cross-section of the optical sheet is described in more detail. FIG. 7 shows a cross-section of the optical sheet along the VII-VII line in FIG. 6 corresponding to the main cross-section of the optical sheet, and FIG. 8 shows the surface light source device 20 in a cross-section in parallel with the main cross-section of the optical sheet. As shown in FIGS. 7 and 8, in this embodiment, the cross-sectional shape of each unit prism 70 in the main cross-section of the optical sheet is tapered toward the light entrance side (toward the light guide plate). Namely, in the main cross-section, the width of each unit prism 70, along a direction parallel to the sheet plane of the optical sheet 60, decreases with distance from the body part 65 along the normal direction nd of the optical sheet 60.

In this embodiment, when an inclining angle θₜ is an angle between the second prism surface 72 forming a part of an outer contour of the unit prism 70 (the second prism surface 72 forming a part of the light entrance side surface) and the first direction d₁ in the main cross-section of the optical sheet 60, the inclining angle θₜ of at least one unit prism 70 is not constant in the second prism surface 72. As shown in FIGS. 7 and 8, in the second prism surface 72, the inclining angle θₜ increases from the distal end portion 75a of the unit prism, farthest from the body part 65, toward the proximal end portion 75b of the unit prism 60, closest to the body part 65. As shown in FIG. 8, such a unit prism 60 can ensure an excellent light condensing effect both in a proximal end portion 75-side area of each second prism surface 72 which relatively high-angle light L81, traveling in a direction inclined at a relatively low angle with respect to the front direction, mainly enters, and in the distal end portion 75a-side area which relatively low-angle light L82, traveling in a direction inclined at a relatively high angle with respect to the front direction, mainly enters.

As a concrete structure, there are element surfaces 73 the number of which is n (n is a natural number of 2 or more), i.e., a plurality of the element surfaces, the element surfaces 73 being located such that the inclining angle θₜ gradually increases in the main cross-section of the optical sheet, from the distal end portion 75a of the unit prism 70 toward the proximal end side 65b. In the illustrated embodiment, in the cross-section of the optical sheet, a contour of the second prism surface 72 of the unit prism 70 has a shape composed of connected line segments or of connected line segments whose connection(s) is chamfered. In other words, the outer contour of the second prism surface 72 of the unit prism 70 has a polygonal line shape, or a shape composed of a polygonal line whose corner(s) is chamfered. Particularly in the illustrated embodiment, the second prism surface 72 includes a first element surface 73a defining the distal end portion 75a, and a second element surface 73b adjacent from the side of the body part 65 to the first element surface 73a. As shown in FIG. 7, an inclining angle θ₁ of the first element surface 73a is smaller than an inclining angle θ₂ of the second element surface 73b.

As described above, the inclining angels θₜ, θ₁, and θ₂ are angels between the light entrance side surface of the unit prism 60 (second prism surface 72) and the first direction d₁ in the main cross-section of the optical sheet 60. An angle formed between each element surface 73 defining the polygonal line and the first direction d₁ (more precisely the smaller one (minor angle) of the two angles formed) is the inclining angel θₜ, θ₁, or θ₂.

In the optical sheet 60 having the aforementioned structure, a ratio (W_{b}/H_{b}) of the width W_{b} (see FIG. 8) of the second prism surface 72 of the unit prisms 70 along the arrangement direction of the unit prisms 70 in the main cross-section of the optical sheet, with respect to the height H_{b} of the unit prism 70 along the normal direction nd of the body part 65 in the main cross-section of the optical sheet, affects the light condensing properties and light diffusing properties of the optical sheet 60. Naturally, the inclining angle θₜ of each element surface 73 also affects the light condensing properties and light diffusing properties of the optical sheet 60. It has been found in the present inventors' studies that the following conditions (a) to (c) are preferably satisfied regarding the optical sheet 60.

$$\begin{matrix}3.25 ≦ {\sum }_{t = 1}^{n} ( \vert {θ}_{t} - {θ}_{ave} \vert \times ( {W}_{t} / {W}_{b 2} ) ) ≦ 8.50 & ( a ) \\ {θ}_{ave} = {\sum }_{t = 1}^{n} ( {θ}_{t} \times ( {W}_{t} / {W}_{b 2} ) ) & ( b ) \\ 1.15 ≦ {W}_{b} / {h}_{b} ≦ 1.4 & ( c )\end{matrix}$$

It has been found by the present inventors that, when the conditions (a) to (c) regarding the inclining angle θₜ and the ratio (W_{b}/H_{b}) are satisfied, the optical sheet 60 in combination typically with the light guide plate 30 having predetermined optical properties due to the above structure could efficiently align the profile of the angular distribution of luminance in the plane along first direction d₁, and the profile of the angular distribution of luminance in the plane along the second direction d₂, while maintaining high the front-direction luminance.

As shown in FIG. 7, “θₜ” in the above conditions is the aforementioned inclining angle of the element surface 73, which is located at a t-th position (t is a natural number satisfying 1≦t≦n) from the side of the distal end portion 75a of the unit prism 70 toward the side of the proximal end portion 75b thereof, in the main cross-section of the optical sheet. “Wₜ” is a width of the t-th element surface 73 (t is a natural number satisfying 1≦t≦n) along the first direction d₁. “W_{b2}” is a width of the second prism surface 72 along the first direction d₁.

Other dimensions of the optical sheet 60 may be set as follows. In a specific example of the unit prisms 70 having the above construction, the arrangement pitch P of the unit prisms (equal to the width W_{b} of each unit prism 70 in the illustrated embodiment) may be not less than 10 μm and not more than 200 μm. In view of the fact that the array of unit prisms 70 is rapidly becoming finer these days, the arrangement pitch P of the unit prisms 70 may preferably be not less than 10 μm and not more than 40 μm. Similarly, the width W_{b2} of the second prism surface 72 of the unit prism 70 may be not less than 5 μm and not more than 100 μm. In view of the recent circumstances, the width W_{b2} of the second prism surface 72 of the unit prism 70 may be not less than 5 μm and not more than 20 μm. In addition, the height H_{b} of the unit prisms 70 from the body part 65 along the normal direction nd to the sheet plane of the optical sheet 60 may be not less than 5.5 μm and not more than 180 μm. In addition, the inclining angle θ₁ at the first element surface 73a of the second prism surface 72 may be not less than 45° and not more than 60°. The inclining angle θ₂ at the second element surface 73b of the second prism surface 72 may be not less than 50° and not more than 70°.

The thus constructed optical sheet 60 can be produced, e.g., by shaping the optical sheet 60 on a substrate or by extrusion. While various materials can be used for the body part 65 of the optical sheet 60 and the unit prisms 70, it is preferred to use those materials which are widely used for optical sheets to be incorporated into display devices, have excellent mechanical properties, optical properties, stability and processability, and are commercially available at low costs. Examples of such materials include a transparent resin mainly comprising at least one of an acrylic resin, polystyrene, polycarbonate, polyethylene terephthalate, polyacrylonitrile, etc., and a reactive resin (e.g. ionizing radiation curable resin) such as an epoxy acrylate resin or a urethane acrylate resin.

When optical sheet 60 is produced by curing an ionizing radiation curable resin on a substrate, it is possible to form, together with the unit prisms 70, a sheet-like land portion between the unit prisms 70 and the substrate. In this case, the body part 65 is composed of the substrate and the land portion formed from the ionizing radiation curable resin. On the other hand, in the optical sheet 60 produced by extrusion, the body part 65 and the unit prisms 70 on the light entrance side surface 67 of the body part 65 may be integrally formed with each other.

The operation of the thus-constructed display device 10 will now be described.

As shown in FIGS. 1 and 2, light emitted by the light emitters 25 of the light source 24 passes through the light entrance surface 33 and enters the light guide plate 30. As shown in FIG. 2, lights L21, L22 that have entered the light guide plate 30 repeat reflection, in particular total reflection at the light exit surface 31 and the back surface 32 due to the difference in refractive index between air and the material of the light guide plate 30, and travels in the first direction (light guide direction) d₁ connecting the light entrance surface 33 and the opposite surface 34 of the light guide plate 30.

The back surface 32 of the light guide plate 30 includes the inclined surfaces 37 which are each inclined such that the distance to the light exit surface 31 decreases with the increasing distance from the light entrance surface 33. Two adjacent inclined surfaces 37 are connected via a stepped surface 38 and a connecting surface 39. The stepped surfaces 38 extend in the normal direction nd of the plate plane of the light guide plate 30. Therefore, most of light, traveling in the light guide plate 30 from the light entrance surface 33 toward the opposite surface 34, reflects at an inclined surface(s) 37 or a connecting surface(s) 39 without entering a stepped surface 38. When light is reflected at an inclined surface 37 in the back surface 32, the reflection increases the inclining angle of the traveling direction of the light with respect to the plate plane of the light guide plate 30 in the cross-section shown in FIG. 2. Thus, when light is reflected at an inclined surface 37 in the back surface 32, the reflection decreases the incident angle of the light later entering the light exit surface 31 or the back surface 32. Accordingly, the incident angle of light entering the light exit surface 31 or the back surface 32 decreases by at least one reflection at an incline surface(s) 37 of the back surface 32, and will become less than the critical angle for total reflection. The light can therefore exit the light exit surface 31 or the back surface 32 of the light guide plate 30. The lights L21, L22 that have exited the light exit surface 31 travel toward the optical sheet 60 disposed on the light exit side of the light guide plate 30. On the other hand, light that has exited the back surface 32 is reflected by the reflective sheet 28 disposed behind the light guide plate 30, and re-enters the light guide plate 30 and travels in it.

Particularly in the illustrated embodiment, the proportion of the area of an inclined surface 37 in the back surface 32 increases as the distance of the inclined surface 37 from the light entrance surface 33 in the light guide direction increases. This makes it possible to ensure a sufficient amount of light, exiting the light exit surface 31 of the light guide plate 30, in a region remote from the light entrance surface 33 where the amount of exiting light tends to be small, thereby making uniform the distribution of the amount of exiting light along the light guide direction.

The light exit surface 31 of the illustrated light guide plate 30 is composed of the unit optical elements 50. The cross-sectional shape of each unit shaped element 50 in the main cross-section is a pentagonal shape which is symmetrical with respect to the front direction, or a generally pentagonal shape in which one or more corners of the pentagonal shape are chamfered. In particular, as described above, the light exit surface 31 of the light guide plate 30 is configured as bent surfaces which are inclined with respect to the back surface 32 of the light guide plate 30 (see FIG. 5). The bent surfaces consist of the pairs of inclined surfaces 35, 36. The inclined surfaces 35, 36 of each pair are inclined symmetrically with respect to the normal direction nd to the light exit-side surface 41 of the base portion 40. Light which totally reflects at the inclined surfaces 35, 36 and travels in the light guide plate 30 and light which passes through the inclined surfaces 35, 36 and exits the light guide plate 30 are subject to the following effects of the inclined surfaces 35, 36. The effects to be exerted on light which totally reflects at the inclined surfaces 35, 36 and travels in the light guide plate 30 will be described first.

FIG. 5 shows, in the main cross-section of the light guide plate 30, the paths of lights L51, L52 which travel in the light guide plate 30 while repeating total reflection at the light exit surface 31 and the back surface 32. As described above, each pair of the inclined surfaces 35, 36, constituting the light exit surface 31 of the light guide plate 30, are inclined symmetrically with respect to the normal direction nd to the light exit-side surface 41 of the base portion 40. The two types of symmetrically inclined surfaces 35, 36 are arranged alternately along the second direction d₂. As shown in FIG. 5, the lights L51, 52, traveling in the light guide plate 30 toward the light exit surface 31 and reaching the light exit surface 31, in most cases reach an inclined surface which is inclined toward the opposite direction to the traveling directions of the lights from the normal direction nd to the light exit-side surface 41 of the base portion 40 in the main cross-section of the light guide plate 30.

Consequently, as shown in FIG. 5, when the lights L51, L52, traveling in the light guide plate 30, totally reflect at the inclined surfaces 35, 36 of the light exit surface 31, the reflection in most cases reduces a light component along the second direction d₂. Further, in some cases, the lights L51, L52 come to travel in a direction inclined oppositely from the front direction nd in the main cross-section. In this manner, the inclined surfaces 35, 36, constituting the light exit surface 31 of the light guide plate 30, restrains light, emitted radially from a light emitting point, from keeping spreading out in the second direction d₂. Thus, light which has been emitted from a light emitter 25 of the light source 24 in a direction highly inclined with respect to the first direction d₁ and entered the light guide plate 30, comes to travel mainly in the first direction d₁ while the light is restrained from traveling in the second direction d₂. This makes it possible to control the distribution of the amount of light, exiting the light exit surface 31 of the light guide plate 30, along the second direction d₂ by the construction of the light source 24 (e.g. the arrangement of the light emitters 25), the output of each light emitter 25, etc.

A description will now be given of an optical effect to be exerted on light passing through the light exit surface 31 and exiting the light guide plate 30. As shown in FIG. 5, lights L51, L52, exiting the light guide plate 30 through the light exit surface 31, are refracted at the light exit-side surfaces of the unit optical elements 50, constituting the light exit surface 31 of the light guide plate 30. Due to the refraction, the lights L51, L52, each traveling in a direction inclined from the front direction nd, are bent such that the angle of the traveling direction (exit direction) of each light with respect to the front direction nd in the main cross-section becomes smaller. Thus, the unit optical elements 50 can reduce a light component along the second direction d₂ perpendicular to the light guide direction and narrow the traveling direction of transmitted light down to the front direction nd. The unit optical elements 50 thus exert a light condensing effect on a light component traveling in the second direction d₂ perpendicular to the light guide direction. In this manner, the exit angle of light exiting the light guide plate 30 is narrowed down to a narrow angular range around the front direction in a plane parallel to the arrangement direction of the unit optical elements 50 of the light guide plate 30.

As described above, the exit angle of light exiting the light guide plate 30 is narrowed down to a narrow angular range around the front direction in a plane parallel to the arrangement direction of the unit optical elements 50 of the light guide plate 30. On the other hand, as shown in FIG. 2, since light travels in the light guide plate 30 mainly in the first direction d₁, light generally exits the light guide plate 30 at a relatively large exit angle θₖ, i.e. exits the light guide plate 30 in a direction relatively highly inclined from the front direction nd. Namely, the exit angle of the first-direction component of light exiting the light guide plate 30 (the angle θₖ (see FIG. 2)) formed between the first-direction component of exiting light and the normal direction nd to the plate plane of the light guide plate 30) tends to lie in a narrow angular range of relatively large angles.

For example, in the light guide plate 30 having the above illustrated shape and dimensions, in an angular distribution of luminance on the light exit surface 31 of the light guide plate 30 toward respective directions in a plane in parallel both with the normal direction nd of the light guide plate 30 and the first direction d₁, θₐₗₘₐₓ₁ defined by an inclining angle wherein a direction in which a peak luminance is obtained is inclined from the normal direction nd of the light guide plate 30 to the other side (side of the opposite surface 34) along the first direction d₁, and θ_{alα1} defined by an inclining angle wherein a direction in which a luminance half of the peak luminance is obtained, the direction being located between the normal direction nd of the guide plate 30 and the direction in which the peak luminance is obtained, is inclined from the direction in which the peak luminance is obtained to one side (side of the light entrance surface 33) along the first direction d₁ can be set to satisfy the following conditions (d) and (e), more preferably, conditions (d′) and (e′).

60°≦θ_{aImax1}≦80° (d)

5°≦θ_{aIα1}≦25° (e)

70°≦θ_{aImax1}≦80° (d′)

5°≦θ_{aIα1}≦15° (e′).

In the light guide plate 30 having the above illustrated shape and dimensions, in an angular distribution of luminance on the light exit surface 31 of the light guide plate 30 toward respective directions in the main cross-section of the light guide plate 30, θₐₗₘₐₓ₂ defined by an inclining angle wherein a direction in which a peak luminance is obtained is inclined from the normal direction nd of the light guide plate 30, and θ_{alα2} (=(θ_{alα2x}+θ_{alα2y})/2) defined by an average value of inclining angles wherein directions in which a luminance half of the peak luminance is obtained, the directions being located on both sides of the direction in which the peak luminance is obtained, is inclined from the direction in which the peak luminance is obtained can be set to satisfy the following conditions (f) and (g):

0°≦θ_{aImax2}≦3° (f)

12°≦θ_{aIα2}≦27° (g).

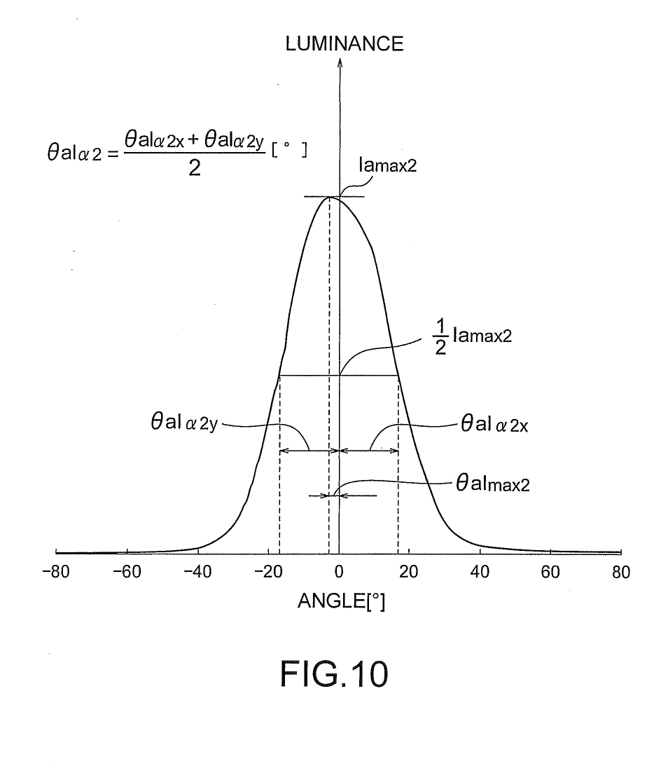

FIGS. 9 and 10 show an example of the angular distribution of luminance measured at the light exit surface 31 of the light guide plate 30. The luminance distribution shown in FIG. 9 is the results of an actual measurement of luminance made in various directions in a plane parallel to both the first direction d₁ and the front direction nd. In the graph shown in FIG. 9, a value of an angle inclined in the other side from the front direction along the first direction is plus. On the other hand, the luminance distribution shown in FIG. 10 is the results of an actual measurement of luminance made in various directions in a plane parallel to both the second direction d₂ and the front direction nd.

Light that has exited the light guide plate 30 enters the optical sheet 60. As described above, the optical sheet 60 has the unit prisms 70 whose distal end portion 75a project toward the light guide plate 30. As well shown in FIG. 2, the longitudinal direction of the unit prisms 70 is parallel to a direction intersecting the light guide direction (the first direction) d₁ in which light is guided in the light guide plate 30, and particularly in this embodiment is parallel to the second direction d₂ perpendicular to the light guide direction.

Accordingly, lights L21, L22, which have been emitted by the light source 24 disposed on one side (left side in FIG. 2) in the first direction d₁, passed through the light guide plate 30, and are traveling toward the optical sheet 60, respectively enter a unit prism 70 through the first prism surface 71, of the first prism surface 71 and the second prism surface 72 connected to each other, located on one side nearer to the light source 24 in the first direction d₁. As shown in FIG. 2, the lights L21, L22 then totally reflect at the second prism surface 72 located on the other side (right side in FIG. 2) farther from the light source 24 in the first direction d₁, thereby changing the traveling direction.

Due to the total reflection at the second prism surfaces 72 of the unit prisms 70, the lights L21, L22, L81, L82, each traveling in a direction inclined from the front direction nd in the main cross-section of the optical sheet shown in FIGS. 2 and 8 (cross-section parallel to both the first direction (light guide direction) d₁ and the front direction nd), are bent such that the angle of the traveling direction of each light with respect to the front direction nd becomes smaller. Thus, with reference to a light component along the first direction (light guide direction) d₁, the unit prisms 70 can narrow the traveling direction of the transmitted light down to the front direction nd. Namely, the optical sheet 60 thus exerts a light condensing effect on a light component along the first direction d₁.

Light whose traveling direction is thus significantly changed by the unit prisms 70 of the optical sheet 60 is mainly a light component traveling in the first direction d₁, i.e. the arrangement direction of the unit prisms 70, and thus differs from the light component traveling in the second direction d₂ which is condensed by the inclined surfaces 35, 36 of the unit optical elements 50 of the light guide plate 30. Accordingly, the front-direction luminance, which has been increased by the unit optical elements 50 of the light guide plate 30, is not impaired and can be further increased by the optical effect of the unit prisms 70 of the optical sheet 60.

The light of one polarization component which has exited the optical sheet 60 forming the light emitting surface 21 of the surface light source device 20 then enters liquid crystal display panel 15 and passes through the lower polarizing plate 14. Light that has passed through the lower polarizing plate 14 selectively passes through the upper polarizing plate 13 depending on the application of an electric field to each pixel. By thus selectively transmitting light from the surface light source device 20 for each pixel by means of the liquid crystal display panel 15, a viewer can view an image on the liquid crystal display device 10.

As mentioned in the Background Art section, recently, small portable terminals called cellular phone and tablet have become prevalent rapidly. In a display device of a cellular phone or a small portable terminal, an orientation in which an image is displayed is changed depending on a direction in which the cellular phone or the small portable terminal is held. A user can suitably observe an image in a horizontally long display surface or in a vertically long display surface, depending on an image to be displayed. In a surface light source device used for this application, non-uniformity of luminance angular distributions in two planes perpendicular to each other is preferably reduced in order not that brightness of image and a viewing angle change depending on an orientation in which an image is observed. On the other hand, the cellular phone and the small portable terminal are eagerly required to have a high luminance in a front direction, while saving electric power.

However, as can be understood by comparing the angular distributions of luminance shown in FIGS. 9 and 10, light that has exited from the light guide plate shows significantly intensive directivity. Thus, it is particularly difficult to align profiles of angular distribution of luminance in two planes perpendicular to each other measured at the light emitting surface, while maintaining high front-direction luminance, and there has been no established method of aligning profiles of angular distribution of luminance in two planes perpendicular to each other measured at the light emitting surface.

On the other hand, it has been found by the present inventors that the optical sheet 60 satisfying the conditions (a) to (c) regarding the inclining angle θₜ and the ratio (W_{b}/H_{b}), in combination with the light guide plate 30 having predetermined optical properties (properties satisfying the aforementioned conditions (d) and (e), more preferably, the conditions (d′) and (e′), or properties further satisfying the aforementioned conditions (f) and (g) in addition to the aforementioned conditions (d) and (e), more preferably, the conditions (d′) and (e′)), could efficiently align the profile of angular distribution of luminance in the plane along the first direction d₁ and the profile of angular distribution of luminance in the plane along the second direction d₂ to each other, while maintaining high the front-direction luminance.

$$\begin{matrix}3.25 ≦ {\sum }_{t = 1}^{n} ( \vert {θ}_{t} - {θ}_{ave} \vert \times ( {W}_{t} / {W}_{b 2} ) ) ≦ 8.50 & ( a ) \\ {θ}_{ave} = {\sum }_{t = 1}^{n} ( {θ}_{t} \times ( {W}_{t} / {W}_{b 2} ) ) & ( b ) \\ 1.15 ≦ {W}_{b} / {h}_{b} ≦ 1.4 & ( c )\end{matrix}$$

As shown in FIG. 7, “θ_{f}” in the above conditions is the aforementioned inclining angle of the element surface 73, which is located at a t-th position (t is a natural number satisfying 1≦t≦n) from the side of the distal end portion 75a of the unit prism 70 toward the side of the proximal end portion 75b thereof, in the main cross-section of the optical sheet. “Wₜ” is a length (width) of the t-th element surface (t is a natural number satisfying 1≦t≦n) along the first direction d₁. “W_{b2}” is a length (width) of the second prism surface 72 along the first direction d₁. They are specified in the main cross-section of the optical sheet shown in FIG. 7.

“θₐᵥₑ” determined by the condition (b) is an index showing the whole inclining angle of the second prism surface 72 in consideration of the width Wₜ of each element surface 73. “Σ(|θₜ−θₐᵥₑ|×(Wₜ/W_{b2}))” in the condition (a) is an index showing dispersion of the inclining angle θₜ of the element surface 73 of the one second prism surface 72. Thus, by satisfying the condition (a), the excellent light condensing effect on the second prism surfaces 72 formed of the element surfaces 73, which was explained with reference to FIG. 8, can be ensured. On the other hand, the condition (c) generally determines the degree of light condensing effect of the optical sheet 60. As a result, it can be estimated that the optical sheet 60 satisfying the conditions (a) to (c), in combination typically with the light guide plate 30 having predetermined optical properties (properties satisfying the aforementioned conditions (d) and (e), more preferably, the conditions (d′) and (e′), or properties further satisfying the aforementioned conditions (f) and (g) in addition to the aforementioned conditions (d) and (e), more preferably, the conditions (d′) and (e′)), can efficiently align the profile of angular distribution of luminance in the plane along the first direction d₁ and the profile of angular distribution of luminance in the plane along the second direction d₂ to each other, while maintaining high the front-direction luminance.

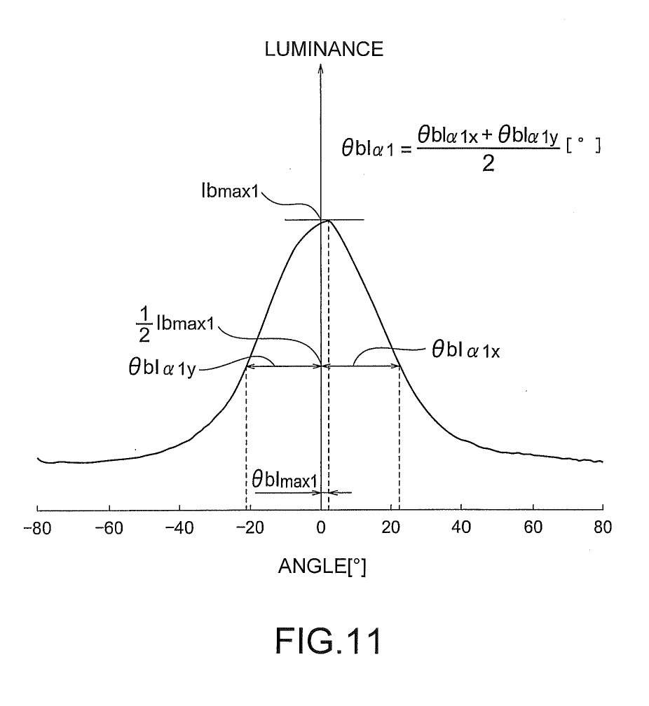

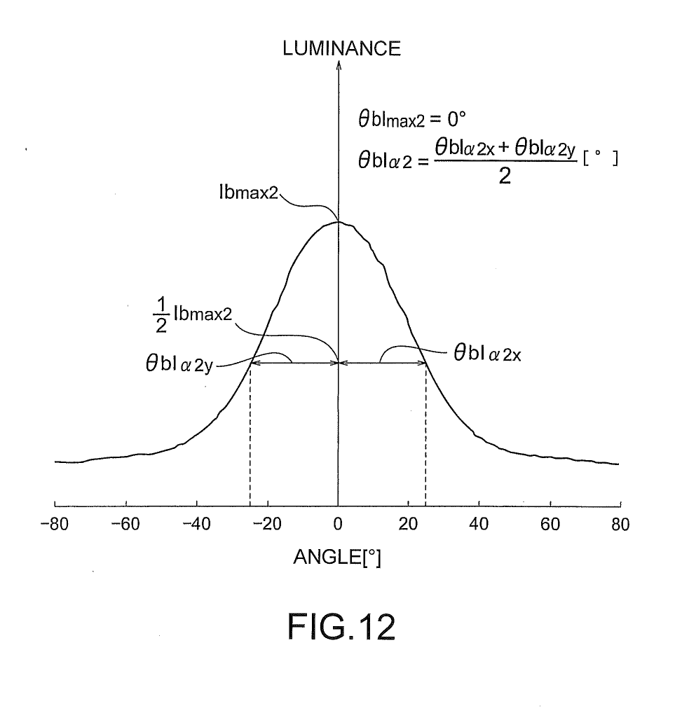

FIGS. 11 and 12 show an example of the angular distribution of luminance measured at the light exit surface 61 of the optical sheet 60. The luminance distribution shown in FIG. 11 is the results of an actual measurement of luminance made in various directions in a plane parallel to both the first direction d1 and the front direction nd. In the graph shown in FIG. 11, similarly to the graph shown in FIG. 9, a value of an angle inclined in the other side from the front direction along the first direction is plus. On the other hand, the luminance distribution shown in FIG. 12 is the results of an actual measurement of luminance made in various directions in a plane parallel to both the second direction d₂ and the front direction nd.

The surface light source device 20 whose angular distribution of luminance in FIGS. 11 and 12 is measured is the same as the surface light source device 20 whose angular distribution of luminance in FIGS. 9 and 10 is measured. Namely, the luminance properties of FIGS. 11 and 12 are obtained by correcting the light path of exit light from the light guide plate 30 showing the luminance properties of FIGS. 9 and 10 by means of the optical sheet 60 satisfying the conditions (a) to (c). As shown in FIGS. 9 and 10, the luminance properties on the light exit surface 31 of the light guide plate 30 significantly differ in the angular distribution of luminance in the plane along the first direction d₁ and the angular distribution of luminance in the plane along the second direction d₂. On the other hand, as shown in FIGS. 11 and 12, the luminance properties on the light exit surface 61 of the optical sheet 60 show substantially the same profiles of the angular distribution of luminance in the plane along the first direction d₁ and the angular distribution of luminance in the plane along the second direction d₂. Actually, in a case where the surface light source device having the luminance properties of FIGS. 11 and 12 was incorporated in a portable terminal, even when an image was viewed while changing orientation of a display device, neither change in the brightness of image nor change in in view angle could be perceived by naked eyes.

According to this embodiment, the second prism surface 72 includes the element surfaces the number of which is n (n is a natural number of 2 or more), the element surfaces being arranged such that, in the main cross-section of the optical sheet, an inclining angle θₜ with respect to the first direction d₁ gradually increases from the side of the distal end portion 75a of the unit prism 70 farthest from the body part 65 toward the side of the proximal end portion 75b of the unit prism 70 closest to the body part 65. The following two conditions (a) and (b) are satisfied, when θₜ is an angle between an element surface 73, which is located at a t-th position (t is a natural number satisfying 1≦t≦n) from the side of the distal end portion 75a toward the side of the proximal end portion 75b, and the first direction in the main cross-section of the optical sheet, the angle θₜ being less than 180°, Wₜ is a length of the t-th element surface 73 along the first direction d₁, and W_{b2} is a length of the second prism surface 72 in the main cross-section of the optical sheet along the first direction d₁. In addition, in the main cross-section of the optical sheet, a ratio (W_{b}/H_{b}) of a width W_{b} of the unit prism 70 along the first direction d₁ with respect to a height H_{b} of the unit prism 70 along the normal direction nd of the body part 65 satisfies the following condition (c).

$$\begin{matrix}3.25 ≦ {\sum }_{t = 1}^{n} ( \vert {θ}_{t} - {θ}_{ave} \vert \times ( {W}_{t} / {W}_{b 2} ) ) ≦ 8.50 & ( a ) \\ {θ}_{ave} = {\sum }_{t = 1}^{n} ( {θ}_{t} \times ( {W}_{t} / {W}_{b 2} ) ) & ( b ) \\ 1.15 ≦ {W}_{b} / {h}_{b} ≦ 1.4 & ( c )\end{matrix}$$

The optical sheet 60 satisfying the conditions (a) to (c), in combination with the light guide plate satisfying the conditions (d) and (e), more preferably, the conditions (d′) and (e′), can effectively make uniform the angular distributions of luminance in two planes perpendicular to each other, while maintaining a high front-direction luminance.

“θₐₗₘₐₓ₁^{”} in the conditions (d) and (d′) is an angle defined by an inclining angle wherein a direction in which a peak luminance is obtained is inclined from the normal direction nd of the light guide plate 30 to the other side along the first direction d₁, in an angular distribution of luminance on the light exit surface 31 of the light guide plate 30 toward respective directions in a plane in parallel both with the normal direction nd of the light guide plate and the first direction d₁. In addition, “θ_{alα1}” in the conditions (e) and (e′) is an angle defined by an inclining angle wherein a direction in which a luminance half of the peak luminance is obtained, the direction being located between the normal direction nd of the guide plate 30 and the direction in which the peak luminance is obtained, is inclined from the direction in which the peak luminance is obtained to one side along the first direction d₁.

60°≦θ_{aImax1}≦80° (d)

5°≦θ_{aIα1}≦25° (e)

70°≦θ_{aImax1}≦80° (d′)

5°≦θaIα1≦15° (e′).

The optical sheet 60 satisfying the conditions (a) to (c), in combination with the light guide plate 30 further satisfying the conditions (f) and (g) in addition to the conditions (d) and (e), more preferably, the conditions (d′) and (e′), can more effectively make uniform the angular distributions of luminance in two planes perpendicular to each other, while maintaining a high front-direction luminance.

“θₐₗₘₐₓ₂” in the condition (f) is an angle defined by an inclining angle wherein a direction in which a peak luminance is obtained is inclined from the normal direction nd of the light guide plate 30, in an angular distribution of luminance on the light exit surface 31 of the light guide plate 30 toward respective directions in a plane in parallel with the normal direction nd of the light guide plate 30 and perpendicular to the first direction d₁. In addition, “θ_{alα2}” in the condition (g) is an angle defined by an average value of inclining angles wherein directions in which a luminance half of the peak luminance is obtained, the directions being located on both sides of the direction in which the peak luminance is obtained, is inclined from the direction in which the peak luminance is obtained.

0°≦θ_{aImax2}≦3° (f)

12°≦θ_{aIα2}≦27° (g)

Various changes and modifications may be made to the embodiments described above. A modification example is described with reference to the drawings. In the following description and relevant drawings, the same reference numerals are used to indicate the same or equivalent components as used in the above-described embodiments, and a duplicate description thereof is omitted.

While an example of the unit prisms 70 of the optical sheet 60 has been described above, various modifications may be made thereto. For example, the unit prism 70 may have different constructions. While the second prism surface 72 has the two element surfaces 73, the second prism surface 72 may include three or more element surfaces 73. Further, not limited to the concrete example shown in FIGS. 7 and 8, the cross-sectional shape in the main cross-section of the unit prism 70 may be a pentagonal shape, a hexagonal shape and so on.

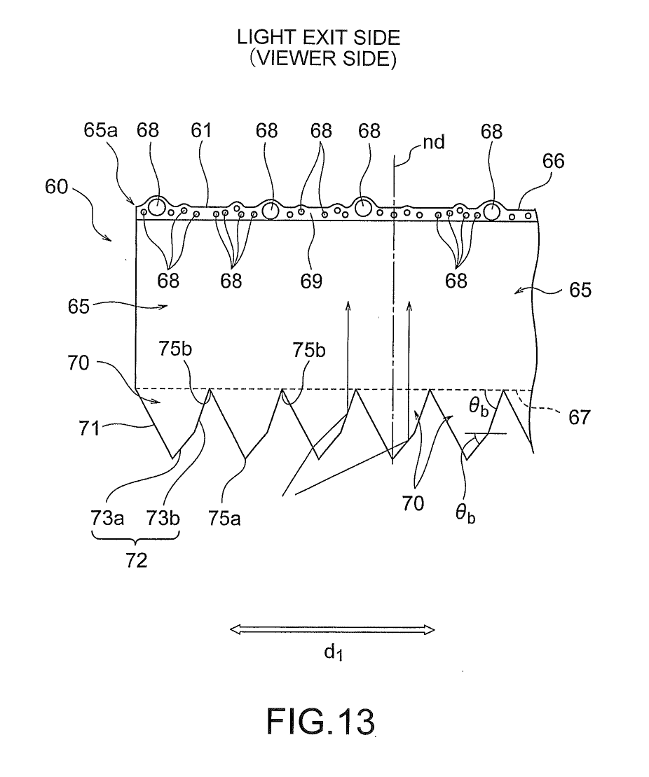

In addition, as shown in FIG. 13, a light diffusion layer (mat layer) 65a may be formed on the light exit surface 61 opposite to the surface of the optical sheet 60 formed by the unit prisms 70. In the example shown in FIG. 13, the light diffusion layer 65a includes a binder resin 69, and light diffusion particles 68 dispersed in the binder resin 69. The light diffusion effect of the light diffusion layer 65a is preferably set such that an angular range within which a luminance half of the peak luminance is obtained is not less than 0.8°, when parallel beams of light enter the light diffusion layer 65a. In this case, the light diffusing effect of the light diffusion layer 65a can make invisible a defect in the optical sheet 60 and/or the light guide plate 30 and hide them. For example, if a bright point or a dark point (point defect) is formed e.g. due to a scratch or a dent produced during the production of the optical sheet 60 or the light guide plate 30, the light diffusing effect of the light diffusion layer 65a can make the defect invisible. The light diffusing effect of the mat layer 65a can broaden the allowable range of defects in the reflective sheet 28, the light guide plate 30 or the mat layer 65a. This can increase the yield of the reflective sheet 28, the light guide plate 30 or the mat layer 65a. Further, the light diffusing effect of the mat layer 65a can smoothen the angular distribution of luminance, measured on the light emitting surface 21 of the light source device 20. This makes it possible to effectively avoid a significant change in the brightness of an image when a viewer changes the angle of viewing the image, and to provide an angular range (viewing angle) that enables appropriate viewing of images.

However, excessively strong light diffusing effect of the light diffusion layer 65a decreases the front-direction luminance decreases. From this viewpoint, the light diffusing effect of the light diffusion layer 65a is preferably set such that an angular range within which a luminance half of the peak luminance is obtained is not more 2.6°, when parallel beams of light enter the light diffusion layer 65a.

Moreover, while an example of the unit optical elements 50 of the light guide plate 30 has been described above, various modifications may be made thereto. For example, the unit optical elements 50 contained in the light guide plate 30 may have different constructions. Further, each unit optical element 50 may have a cross-sectional shape other than that shown in FIG. 5 in the main cross-section, for example, a triangular shape or a semicircular shape.

Though not shown diagrammatically, a known reflective polarizer (also called a polarization separation film) may be disposed between the light exit surface of the optical sheet 60 (the light emitting surface 21 of the surface light source device in FIG. 1) and the lower polarizing plate 14 of the liquid crystal display panel 15 in the surface light source device 20. The reflective polarizer transmits only a particular polarization component of light exiting the optical sheet 60, and does not absorb but reflects a polarization component perpendicular to the particular polarization component. The polarization component reflected from the reflective polarizer is reflected by the reflective sheet 28, etc., whereby the polarization component is depolarized (converted into light comprising both the particular polarization component and the polarization component perpendicular to the particular polarization component). The depolarized light re-enters the reflective polarizer. The reflective polarizer transmits the particular polarization component of the depolarized light and reflects again the polarization component perpendicular to the particular polarization component. The above process is repeated, whereby about 70 to 80% of exiting light from the optical sheet 60 becomes the particular polarization component and exits the reflective polarizer. Thus, by making the polarization direction of the particular polarization component (transmission axis component) for the reflective polarizer coincide with the transmission axis direction of the lower polarizing plate 14 of the liquid crystal display panel 15, it becomes possible to use all the exiting light from the surface light source device 20 for the formation of an image on the liquid crystal display panel 15. Therefore, compared to the case of not using a reflective polarizer, an image can be formed with higher brightness even though the same amount of light energy is supplied from the light source 24, and the use efficiency of the energy of the light source 24 (or its power source) can be increased.

The modifications described above can of course be made in an appropriate combination to the above-described embodiments.

### Examples

The following examples will further illustrate the present invention in greater detail without limiting its scope.

Surface light source device samples were produced in the following manner. The surface light source device had the same structure as that of the one embodiment described with reference to FIGS. 1 to 8. Namely, the surface light source device included a light source, a light guide plate and an optical sheet. The light guide plate had the same structure as that of the one embodiment described with reference to FIGS. 1 to 8. A reflective sheet and a light source incorporated in a commercially available liquid crystal display device were used. The same light guide plate, the reflective sheet and the light source were commonly used in the respective surface light source devices. The light guide plate, the reflective sheet, and the light source showed luminance properties shown in FIGS. 9 and 10.

Different optical sheets were produced for the respective surface light source devices. The produced optical sheets were different from one another in cross-sectional shape in the main cross-section of the optical sheet, and were the same with one another in other points. Namely, each optical sheet included a sheet-like body part and unit prisms arranged on the body part. Each optical sheet was produced by shaping unit prisms on one surface of a PET film having a thickness of 125 μm manufactured by Toyobo Co., Ltd., A4300), using a UV curable resin (DIC Corporation, RC25-750). Respective dimensions of the optical sheets in the main cross-section of the optical sheet are shown in Table 1. The respective dimensions in Table 1 are those described in the aforementioned embodiment, and in more detail as same as the respective dimensions shown in FIGS. 7 and 8. Table 1 also shows whether the respective optical sheets respectively satisfy the conditions (a) and (c) or not.

The following points were inspected for the respective surface light source devices. Values of the respective inspected angles are shown in Table 1.

(1) θ_{blmax1} defined by an angle between the direction in which the peak luminance is obtained and the front direction, in an angular distribution of luminance on the light exit surface of the optical sheet toward respective directions in a plane in parallel both with the front direction and with the first direction d₁.
(2) θ_{blα1} defined by an average angle value of inclining angles wherein directions in which a luminance half of the peak luminance is obtained, the directions being located on both sides of the direction in which the peak luminance is obtained, are inclined from the direction in which the peak luminance is obtained, in an angular distribution of luminance on the light exit surface of the optical sheet toward respective directions in a plane in parallel both with the front direction and the first direction d₁.
(3) θ_{blmax2} defined by an angle between the direction in which the peak luminance is obtained and the front direction, in an angular distribution of luminance on the light exit surface of the optical sheet in a plane in parallel both with the front direction and with the second direction d₂.
(4) θ_{blα2} defined by an average angle value of inclining angles wherein directions in which a luminance half of the peak luminance is obtained, the directions being located on both sides of the direction in which the peak luminance is obtained, are inclined from the direction in which the peak luminance is obtained, in an angular distribution of luminance on the light exit surface of the optical sheet toward respective directions in a plane in parallel both with the front direction and the second direction d₂.
(5) θₐₗₘₐₓ₁ defined by an inclining angle wherein the direction in which the peak luminance is obtained is inclined from the front direction to the other side along the first direction, in an angular distribution of luminance on the exit surface of the light guide plate toward respective directions in a plane in parallel both with the front direction and the first direction d₁.
(6) θ_{alα1} defined by an inclining angle wherein a direction in which a luminance half of the peak luminance is obtained, the direction being located between the front direction and the direction in which the peak luminance is obtained, is inclined from the direction in which the peak luminance is obtained to the one side along the first direction, in an angular distribution of luminance on the exit surface of the light guide plate toward respective directions in a plane in parallel both with the front direction and the first direction d₁.
(7) θₐₗₘₐₓ₂ defined by an angle between the direction in which the peak luminance is obtained and the front direction, in an angular distribution of luminance on the light exit surface of the light guide plate in a plane in parallel both with the front direction and with the second direction d₂.
(8) θ_{alα2} defined by an average value of inclining angles wherein directions in which a luminance half of the peak luminance is obtained, the directions being located on both sides of the direction in which the peak luminance is obtained, are inclined from the direction in which the peak luminance is obtained, in an angular distribution of luminance on the exit surface of the light guide plate toward respective directions in a plane in parallel both with the front direction and the second direction d₂.

TABLE 1
Samples and Evaluation Results

| | | Samples | | |
|---|---|---|---|---|
| | | 1 | 2 | 3 |
| Dimension | H_{b}[μm] | 14.2892 | 14.96159 | 13.72 |
| | W_{b}[μm] | 18 | 18 | 18 |
| | W_{b}/H_{b} | 1.259693 | 1.203081 | 1.311953 |
| | W_{b2}[μm] | 9.174811 | 9.500634 | 8.39 |
| | W₁[μm] | 4.573168 | 3.538865 | 1.999031 |
| | W₂[μm] | 4.601643 | 5.961769 | 2.499649 |
| | W₃[μm] | None | None | 3.891061 |
| | θ₁ | 56° | 53.6° | 50° |
| | θ₂ | 58.5° | 59.6° | 56° |
| | θ₃ | None | None | 63° |
| Satisfaction | (a) | Not | Not | Satisfied |
| of | | Satisfied | Satisfied | |
| Condition | (c) | Satisfied | Satisfied | Satisfied |
| Optical | θ_{bImax1} | 0.2° | 0.4° | 0.2° |
| Properties | θ_{bIα1} | 13.5° | 15.5° | 23° |
| | θ_{bImax2} | 0° | 0° | 0° |
| | θ_{bIα2} | 23.5° | 23.5° | 25° |
| | \|θ_{bIα1} − θ_{bIα2}\| | 10° | 8° | 2° |

| | |
|---|---|
| θ_{aImax1} | 76° |
| θ_{aIα1} | 10° |
| θ_{aImax2} | 0.4° |
| θ_{aIα2} | 18° |

It was found by the present inventors that, when |θ_{bIα1}−θ_{bIα2}| was less than 6°, change in the brightness of the display surface could not be perceived by naked eyes, before and after the display surface in which the surface light source device is incorporated was rotated by 90°. Actually, in the surface light source device of Sample 3, change in the brightness could not be detected by naked eye, before and after the light emitting surface was rotated by 90°. On the other hand, in the surface light source devices of Samples 1 and 2, change in the brightness could be detected by naked eye, before and after the light emitting surface was rotated by 90°.

The angular distributions of luminance shown in FIGS. 9 to 12 are measuring results of the surface light source device of Sample 3.

1. A surface light source device comprising:
a light guide plate including a light exit surface, and a pair of side surfaces opposed in a first direction;
an optical sheet disposed to face the light exit surface of the light guide plate; and
a light source disposed to face a side surface of the light guide plate positioned on one side in the first direction;
wherein:
the optical sheet includes a sheet-like body part, and unit prisms arranged on a side of the light guide plate of the body part in the first direction, each unit prism extending linearly in a direction intersecting the first direction;
each unit prim includes a first prism surface facing one side of the first direction, and a second prism surface facing the other side of the first direction;
the second prism surface includes element surfaces the number of which is n (n is a natural number of 2 or more), the element surfaces being arranged such that, in a main cross-section of the optical sheet in parallel both with the first direction and a normal direction of the body part, an inclining angle with respect to the first direction gradually increases from a side of a distal end portion of a unit prism farthest from the body part toward a side of a proximal end portion of a unit prism closest to the body part;
the following two conditions (a) and (b) are satisfied:
$$\begin{matrix}3.25 ≦ {\sum }_{t = 1}^{n} ( \vert {θ}_{t} - {θ}_{ave} \vert \times ( {W}_{t} / {W}_{b 2} ) ) ≦ 8.50 & ( a ) \\ {θ}_{ave} = {\sum }_{t = 1}^{n} ( {θ}_{t} \times ( {W}_{t} / {W}_{b 2} ) ) & ( b )\end{matrix}$$
where θₜ is an angle between an element surface, which is located at a t-th position (t is a natural number satisfying 1≦t≦n) from the side of the distal end portion of the unit prism toward the side of the proximal end portion thereof, and the first direction in the main cross-section of the optical sheet, the angle θₜ being less than 180°, Wₜ is a length of the t-th element surface along the first direction, and W_{b2} is a length of the second prism surface in the main cross-section of the optical sheet along the first direction;
in the main cross-section of the optical sheet, a ratio (W_{b}/H_{b}) of a width W_{b} of the unit prism along the first direction with respect to a height H_{b} of the unit prism along the normal direction of the body part satisfies the following condition (c):
1.15≦W_{b}/H_{b}≦1.4 (c); and
in an angular distribution of luminance on the light exit surface of the light guide plate toward respective directions in a plane in parallel both with a normal direction of the light guide plate and the first direction, θₐₗₘₐₓ₁ defined by an inclining angle wherein a direction in which a peak luminance is obtained is inclined from the normal direction of the light guide plate to the other side along the first direction, and θ_{alα1} defined by an inclining angle wherein a direction in which a luminance half of the peak luminance is obtained, the direction being located between the normal direction of the light guide plate and the direction in which the peak luminance is obtained, is inclined from the direction in which the peak luminance is obtained to one side along the first direction satisfy the following conditions (d) and (e):
60°≦θ_{aImax1}≦80° (d)
5°≦θ_{aIα1}≦25° (e).

2. The surface light source device according to claim 1, wherein:
in an angular distribution of luminance on the light exit surface of the light guide plate toward respective directions in a plane in parallel with the normal direction of the light guide plate and perpendicular to the first direction, θₐₗₘₐₓ₂ defined by an inclining angle wherein a direction in which a peak luminance is obtained is inclined from the normal direction of the light guide plate, and θ_{alα2} defined by an average value of inclining angles wherein directions in which a luminance half of the peak luminance is obtained, the directions being located on both sides of the direction in which the peak luminance is obtained, are inclined from the direction in which the peak luminance is obtained satisfies the following conditions (f) and (g):
θ_{aImax2}≦3° (f)
12°≦θ_{aIα2}≦27° (g).

3. The surface light source device according to claim 1, wherein
a light diffusion layer is formed on a surface opposed to the side of the light guide plate of the optical sheet.

4. The surface light source device according to claim 1, wherein
the second prism surface includes element surfaces the number of which is n (n is a natural number of 3 or more), the element surfaces being arranged such that, in the main cross-section of the optical sheet in parallel both with the first direction and the normal direction of the body part, an inclining angle with respect to the first direction gradually increases from the side of the distal end portion of a unit prism farthest from the body part toward the side of the proximal end portion of a unit prism closest to the body part.

5. A display device comprising:
the surface light source device according to claim 1; and
a display panel disposed to face the surface light source device.

6. A display device comprising:
the surface light source device according to claim 2; and
a display panel disposed to face the surface light source device.

7. A display device comprising:
the surface light source device according to claim 3; and
a display panel disposed to face the surface light source device.

8. A display device comprising:
the surface light source device according to claim 4; and
a display panel disposed to face the surface light source device.
